(19) United States
(12) Patent Application Publication
(10) Pub. No.: US 2016/0198016 A1
(43) Pub. Date: Jul. 7, 2016

(54) TECHNIQUES FOR NETWORK RESOURCE CACHING USING PARTIAL UPDATES

(71) Applicant: ONAVO MOBILE LTD., Menlo Park, CA (US)

(72) Inventors: Roi Tiger, Tel Aviv (IL); Guy Rosen, Sunnyvale, CA (US)

(73) Assignee: ONAVO MOBILE LTD., Menlo Park, CA (US)

(21) Appl. No.: 14/589,124

(22) Filed: Jan. 5, 2015

(51) Int. Cl. H04L 29/08; H04L 12/743; H04L 12/747

(52) U.S. Cl. CPC H04L 67/2852; H04L 45/742; H04L 45/7453

(57) ABSTRACT

Techniques for network resource caching are described. In one embodiment, an apparatus may comprise a client proxy component and a resource component. The client proxy component may receive a request for a data item and transmit a delta update to the client device in response to the request. The resource component may determine that the cached resource hash corresponds to the older version of the data item and determine the current version of the data item. In another embodiment, an apparatus may comprise a prediction component and a cache management component. The prediction component may predict a user interest in receiving a data item on a device. The cache management component may retrieve the data item from a network server in response to the predicted user interest and cache the data item on the device. Other embodiments are described and claimed.

### RELATED APPLICATIONS

This application is related to to U.S. patent application Ser. No. 13/864,902, “Method for Efficient Use of Content Stored in a Cache Memory of a Mobile Device” filed Jun. 6, 2013, the entirety of which is incorporated herein by reference.

### BACKGROUND

Mobile devices may use a radio network interface to perform data communications, such as to a cellular or Wi-Fi access point. Such data communications may expend the battery power of the mobile device and may incur data communication charges. Further, the network bandwidth of a mobile device, particularly where performing data communications using a cellular data network, may be lower than for a device using a wired or Wi-Fi network.

Cellular data networks may use metered data. The amount of data transferred across a cellular data network may be monitored and debited against a user allocation of data. Similarly, the amount of data transferred across a cellular data network may be monitored and the user billed a fee based on the amount.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques for network resource caching. Some embodiments are particularly directed to techniques to techniques for network resource caching using partial updates and with predictive caching based on user context. In one embodiment, for example, an apparatus may comprise a client proxy component and a resource component. The client proxy component may be operative to receive a request for a data item from a client device at a proxy server device, the request comprising a cached resource hash and transmit a delta update to the client device in response to the request, the delta update comprising differences between an older version of the data item and a current version of the data item. The resource component may be operative to determine that the cached resource hash corresponds to the older version of the data item and determine the current version of the data item. In another embodiment, for example, an apparatus may comprise a prediction component and a cache management component. The prediction component may be operative to predict a user interest in receiving a data item on a device, the device connected to a data network. The cache management component may be operative to determine that the data network is associated with a pre-caching policy, retrieve the data item from a network server in response to the predicted user interest and the determination that the data network is associated with the pre-caching policy, and cache the data item on the device. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a caching system.

FIG. 2 illustrates an embodiment of the caching system performing a delta update.

FIG. 3 illustrates an embodiment of the caching system performing an updated delta update.

FIG. 4 illustrates an embodiment of the caching system caching a predicted data item.

FIG. 5 illustrates an embodiment of the caching system caching a data item predicted by a proxy server.

FIG. 6 illustrates an embodiment of a first logic flow for the system of FIG. 1.

FIG. 7 illustrates an embodiment of a second logic flow for the system of FIG. 1.

FIG. 8 illustrates an embodiment of a centralized system for the system of FIG. 1.

FIG. 9 illustrates an embodiment of a distributed system for the system of FIG. 1.

FIG. 10 illustrates an embodiment of a computing architecture.

FIG. 11 illustrates an embodiment of a communications architecture.

FIG. 12 illustrates an embodiment of a radio device architecture.

### DETAILED DESCRIPTION

Various embodiments are directed to techniques for caching network resources on a mobile device. Due to the limited allocated bandwidth and limited energy resources of a mobile device, it may be valuable to reduce the amount of data transmitted to a mobile device. One technique for limiting data transfer is to cache items on the mobile device and, when an updated version of the cached item is requested, to only deliver a delta update to the mobile device. Further, it may be valuable to predict items to cache while a mobile device is on a non-metered network (e.g., a Wi-Fi network) or not using battery power (e.g., connected to a power source) and cache the predicted items at that time. As a result, the embodiments can reduce the expense of network access, increase the speed of network access, and reduce power drain on a mobile device.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

It is worthy to note that “a” and “b” and “c” and similar designators as used herein are intended to be variables representing any positive integer. Thus, for example, if an implementation sets a value for a=5, then a complete set of components 122 illustrated as components 122-1 through 122-a may include components 122-1, 122-2, 122-3, 122-4 and 122-5. The embodiments are not limited in this context.

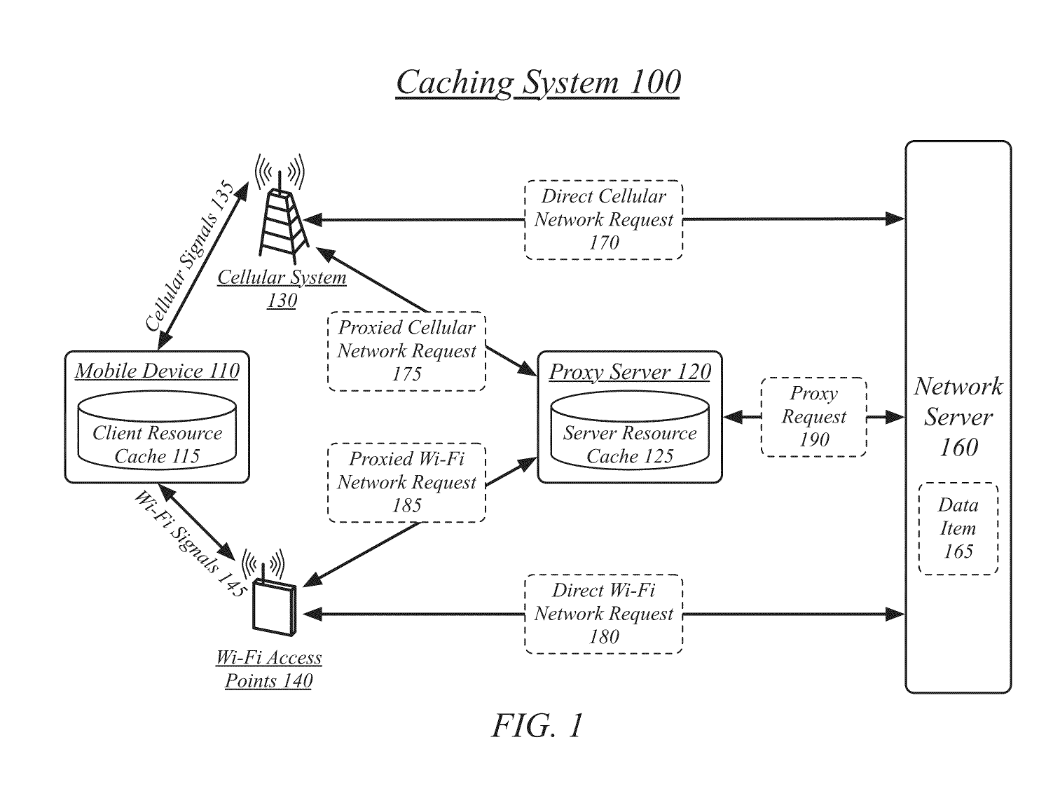

FIG. 1 illustrates a block diagram for a caching system 100. In one embodiment, the caching system 100 may comprise a computer-implemented system having software applications comprising one or more components. Although the caching system 100 shown in FIG. 1 has a limited number of elements in a certain topology, it may be appreciated that the caching system 100 may include more or less elements in alternate topologies as desired for a given implementation.

A mobile device 110 may communicate with other devices using wireless transmissions to exchange network traffic. Exchanging network traffic, such as may be included in the retrieval of a data item 165, may comprise transmitting and receiving network traffic via a network interface controller (NIC). A NIC comprises a hardware component connecting a computer device, such as mobile device 110, to a computer network. The NIC may be associated with a software network interface empowering software applications to access and use the NIC. Network traffic may be received over the computer network as signals transmitted over data links. The network traffic may be received by capturing these signals and interpreting them. The NIC may receive network traffic over the computer network and transfer the network traffic to memory storage accessible to software applications using a network interface application programming interface (API).

A mobile device 110 may perform various operation using network data accessed over a network. The mobile device 110 may access a cellular system 130 using cellular signals 135. The cellular system 130 may be a cellular network including data access, the cellular system 130 provided by a cellular provider with which the user of the mobile device 110 has a service contract, the service contract for cellular data server to the mobile device 110. The cellular system 130 may be a metered network, in which data access is priced, at least in part, according to an amount of data transferred over the network. The cellular data service contract may be a pre-paid contract in that a cellular data allocation is purchased prior to use providing a specific allocation, with cellular data access cut off once the cellular data allocation is exhausted. The cellular data service contract may be a subscription contract providing longer-term cellular data access. A subscription contract may include a cellular data allocation, but may also allow for cellular data use beyond the exhaustion of the cellular data allocation, with any further use generating additional fees. For example, a cellular data subscription may include 1 GB of cellular data per month, with access to zero-rated resources not debited against the allocation, with an additional charge for each full or partial additional gigabyte of cellular data used each month.

The mobile device 110 may access one or more Wi-Fi access points 140 using Wi-Fi signals 145. Wi-Fi access points 140 may be provided by a plurality of different operators. Some of the Wi-Fi access points 140 may be personal in nature, such as a home Wi-Fi network operated by the user of mobile device 110 based on a domestic Internet connection. Some of the Wi-Fi access points 140 may be free of charge or provided as a complimentary portion of a service, such as free Wi-Fi service in coffee shops, hotels, and other public accommodations. Some of the Wi-Fi access points 140 may require payment for use. However, the Wi-Fi access points 140 may be generally non-metered networks, in which, whether access is free or paid, there are no fees for use of the Wi-Fi access points 140 generated based on an amount of data transferred over the networks.

The mobile device 110 may access a data item 165 hosted on a network server 160. The data item 165 may comprise any network-accessible resource. The data item 165 may be retrieved by the mobile device 110, such as in the reception of a video download, video stream, music download, web page view, mobile application download, mobile application data download, or any other reception of data across a network. The data item 165 may be stored on the network server 160, such as the uploading of an image, video, audio file, text message, or any other transmission of data across a network. Accessing the data item 165 may include both transmitting and receiving data, such as the transmission of a request and the reception of a response, the submission of data and the reception of responding data, or any other two-way exchange of data across a network. The mobile device 110 may, in various circumstances, use either of a cellular system 130 or Wi-Fi access points 140 to access the data item 165 on the network server 160.

The mobile device 110 may communicate with network server 160 without the use of any intermediary proxy server 120. The mobile device 110 may use either of cellular system 130 or Wi-Fi access points 140 to access the network server 160 without the network transaction being passed through a proxy server 120. While using the cellular data network provided by the cellular system 130, the mobile device 110 may make a direct cellular network request 170 using the cellular system 130. While using a Wi-Fi data network provided by one of the Wi-Fi access points 140, the mobile device 110 may make a direct Wi-Fi network request 180 using a Wi-Fi access point. When receiving either a direct cellular network request 170 or a direct Wi-Fi network request 180, the network server 160 may transmit the data item 165 back to the mobile device 110 in response to the request. In some embodiments, the mobile device 110 may cache the data item 165 in a client resource cache 115 when receiving the data item via a direct network request 170, 180. In other embodiments, mobile device 110 may not cache the data item 165 in the client resource cache 115 when receiving the data item via a direct network request 170, 180 and only cache the data item 165 in the client resource cache 115 in response to it being received based on a proxied network request 175, 185.

In some embodiments, one or both of the cellular system 130 and Wi-Fi access points may use a proxy server internal to their operations, in which case direct access to the network server 160 may be interpreted as access without the use of third-party proxy servers external to the Wi-Fi access points 140 or cellular system 130.

In some embodiments, the mobile device 110 may be used with a proxy server 120 whether or not it is on a metered network. A proxy server 120 may provide utility to the mobile device 110 beyond data item caching. For example, a proxy server 120 may transcode media to reduce bandwidth, perform anonymization, and provide other benefits. As such, the mobile device 110 may use a proxy server 120 when using a non-metered network such as the networks provided by Wi-Fi access points 140. While using the cellular data network provided by the cellular system 130, the mobile device 110 may make a proxied cellular network request 175 using the cellular system 130 to connect to the proxy server 120. While using a Wi-Fi data network provided by one of the Wi-Fi access points 140, the mobile device 110 may make a proxied Wi-Fi network request 185 using a Wi-Fi access point to connect to the proxy server 120.

When received either a proxied cellular network request 175 or a proxied Wi-Fi network request 185, the proxy server 120 may make a proxy request 190 to the network server 160, the proxy request 190 requesting retrieval of the data item 165 from the network server 160. The network server 160 may transmit the data item 165 back to the proxy server 120 in response to the proxy request 190. The proxy server 120 may cache the data item 165 in the server resource cache and then forward the data item to the mobile device 110. The mobile device 110 may cache the data item in the client resource cache 115.

Caching system 100 may include an authorization server (or other suitable component(s)) that allows users to opt in to or opt out of having their actions logged by caching system 100 or shared with other systems (e.g., third-party systems), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers or other authorization components may be used to enforce one or more privacy settings of the users of caching system 100 and other elements of a social-networking system through blocking, data hashing, anonymization, or other suitable techniques as appropriate.

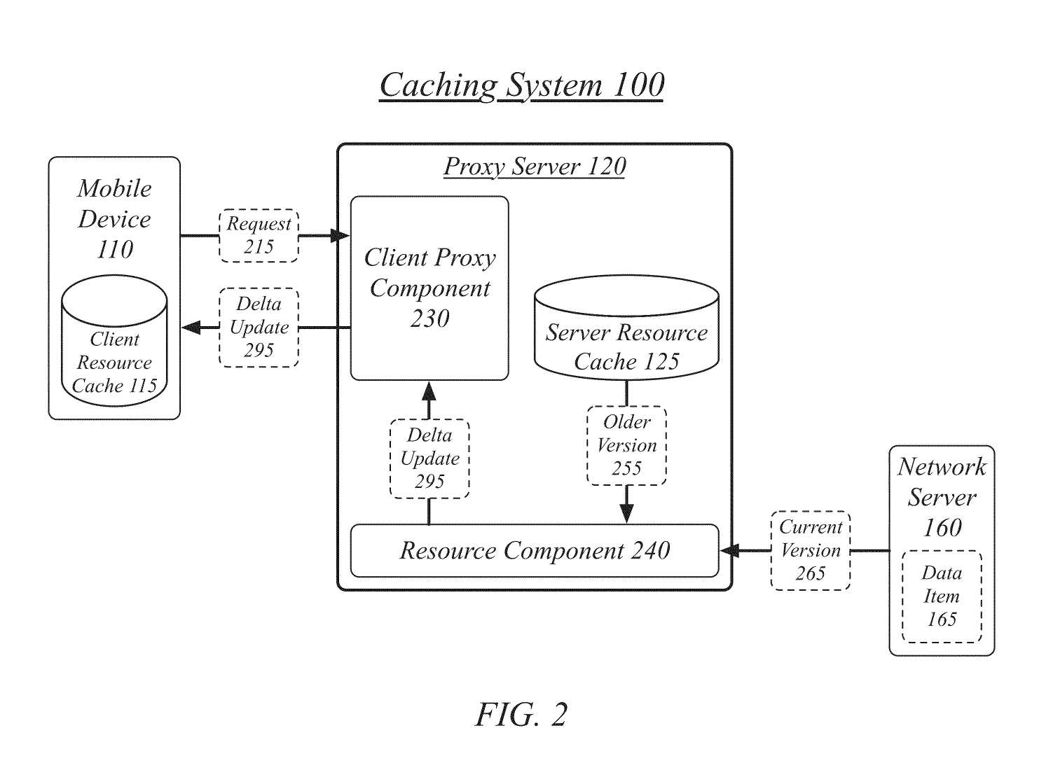

FIG. 2 illustrates an embodiment of the caching system 100 performing a delta update. The proxy server 120 may act as an intermediary to update an older version 255 of a data item 165 cached on a mobile device 110 to a current version 265 of the data item 165 retrieved from a network server 160. The update may be performed using a delta update 295.

The proxy server 120 may comprise a client proxy component 230 and a resource component 240. The proxy server 120 may be generally arranged to perform proxy operations on behalf of a mobile device 110 of a plurality of mobile devices. The proxy server 120 may additionally perform resource caching on behalf of the mobile device 110 and to work in conjunction with a client resource cache 115 on the mobile device 110 to reduce the amount of data transmitted to the mobile device 110, particularly over cellular data connections.

The client proxy component 230 may receive a request 215 for a data item 165 from a client mobile device 110 at a proxy server 120, the proxy server 120 implemented by a proxy server device, the request comprising a cached resource hash.

The cached resource hash may be a hash of an older version 255 of the data item 165. The older version 255 may be cached in both the client resource cache 115 and the server resource cache 125. The cached resource hash being included with the request 215 may comprise a notification to the proxy server 120 that the mobile device 110 has a cache of the older version 255 and may empower the proxy server 120 to identify the specific older version 255 cached on the mobile device 110.

The resource component 240 may determine that the cached resource hash corresponds to the older version 255 of the data item 165. The resource component 240 may perform an index-based retrieval against a server resource cache 125, the cached resource hash used as an index for the index-based retrieval. The resource component 240 may retrieve the older version 255 from the server resource cache 125 using the cached resource hash as an index. A resource address, such as a uniform resource locator (URL) for the data item 165, may also be used to retrieve the older version 255 in conjunction with the cached resource hash. The resource address may be used as a first index to determine a particular data item 165 for retrieval and the cached resource hash may be used as a second index to determine a particular version of that data item 165 to retrieve.

The resource component 230 may determine the current version 265 of the data item 165. In some cases, where the server resource cache 125 stores the current version 265 of the data item 165, the resource component 230 may retrieve the current version 265 from the server resource cache 125. In other cases, where the server resource cache 125 doesn't have a copy of the current version 265 of the data item 165, the resource component 230 may retrieve the current version 265 from the network server 160 hosting it. Even where cached, the resource component 230 may retrieve the current version 265 from the network server 160 in order to confirm which version of the data item 165 is the most recent.

The client proxy component 230 may transmit a delta update 295 to the client mobile device 110 in response to the request 215, the delta update 295 comprising differences between an older version 255 of the data item 165 and a current version 265 of the data item 165. In some cases, the resource component 240 may generate the delta update 295 based on the older version 255 and the current version 265 in response to the request 215. In other cases, the resource component 240 may have already generated the delta update 295, such as in response to a previous request by a different mobile device. In those cases, the resource component 240 may retrieve the delta update 295 from the server resource cache 125 for use by the client proxy component 230.

The resource component 230 may retrieve the current version 265 of the data item 165 from a network server 160 associated with the data item 165, retrieve the older version 255 of the data item 165 from a server resource cache 125 associated with the proxy server 120, and generate the delta update 295 by calculating a differential between the older version 255 of the data item 165 and the current version 265 of the data item 165. The delta update 295 may then be cached in the server resource cache 125. The resource component 240 may generate a current version cache resource hash corresponding to the current version 165 of the data item 165 and store the delta update 295 in the server resource cache 125, the delta update 295 indexed by the current version cache resource hash generated from the current version 265 of the data item 165. The resource component 240 may retrieve the delta update 295 from the server resource cache 125 on the proxy server 120 for use when a mobile device 110 performs a request 215 for the current version 265 and transmits the cached resource hash indicating that they current have cached the older version 255 used with the current version 265 for generating the delta update 295.

The cached resource hash may comprise a hash of the older version 255 of the data item 165 according to a hash function. A hash function may take arbitrary digital data of an arbitrary size and map it to a digital sequence of a specified fixed size. The hash function may perform this mapping in a repeatable manner, such that given the same digital input as data, the same output digital sequence will be produced. The hash function may produce the same output digital sequence independent of the computer device it is calculated on, such that given a same older version 255 stored in the client resource cache 115 and server resource cache 125, the same cached resource hash would be produced by hashing both.

A delta update may comprise an automatically-generated listing of changes between an older version 255 and a current version 265. A variety of known techniques may be used for determining the listing of differences and formatting the listing of differences to represent them in a data file.

In some embodiments, the resource component 240 may be operative to determine that certain elements of a data item 165 are static. These may comprise, for example, elements of the hypertext markup language (HTML) or other source code of a web page that define structural or other static elements of the web page. The resource component 240 may be operative to generate a data item template from the data item 165, the data item template comprising only the static elements of the data item 165. The static items may be identified by, for instance, comparing a plurality of different version of the data item 165 and determining those elements that are common to all of the different version. The resource component 240 may determine that the cached resource hash corresponds to a data item template generated from the older version 255 of the data item 165 and generate the delta update 295 according to the cached data item template. In some cases, a data item template may be generated with administrator assistance in determining the static elements.

The mobile device 110 may be operative to store a two or more cached versions of the data item 165. At least one of the versions may correspond to a cached complete version of the data item 165 with another of the versions corresponding to the data item template. The request 215 may specify one or more hashes corresponding to the cached complete versions and a hash corresponding to the data item template. The proxy server 120 may periodically or occasionally removed cached versions from the server resource cache 125 in order to manage the amount of space dedicated to the storage of cached versions. As such, a request 215 may be received for which the cached completed versions are not present. However, the proxy server 120 and mobile device 110 may prioritize maintaining cached data item templates due to their greater longevity as useful cached resources. As such, the resource component 240 may determine that it does not have a cached version corresponding to any of the one or more cached complete versions cached on the mobile device 110 but it does have the data item template and generate the delta update 295 using the cached data item template in response.

Similarly, in some embodiments, certain dynamic elements may be excluded from the hash. For example, a timestamp for the data item 165—which may be part of the non-rendered code of a web page or which may be a rendered element of an item—may comprise such a dynamic element excluded. This may serve to increase the longevity of a cached version by avoiding re-caching, or marking as non-current, a version of the data item 165 that only differs in dynamic elements that are determined to not be essential to the content of the data item 165. The resource component 240 may construct a modified older version of the data item 165 that excludes one or more dynamic elements of the data item 165. The resource component 240 may determined that a cached resource hash corresponds to a modified older version of the data item 165 and to base the delta update 295 on the modified older version. In some embodiments, the mobile device 110 may be transmitted modified versions of the data item 165 that exclude certain dynamic elements in order to improve caching performance. In other embodiments, the mobile device 110 may be instructed as to the dynamic elements to exclude from the hash, such as through a mask transmitted with the data item 165, the mask applied prior to hashing. In some cases, the modified version may be generated with administrator assistance in determining the dynamic elements to exclude. In other embodiments, certain categories of dynamic elements, such as timestamps, may be specified and a modified version automatically created by removing elements of that category are identified.

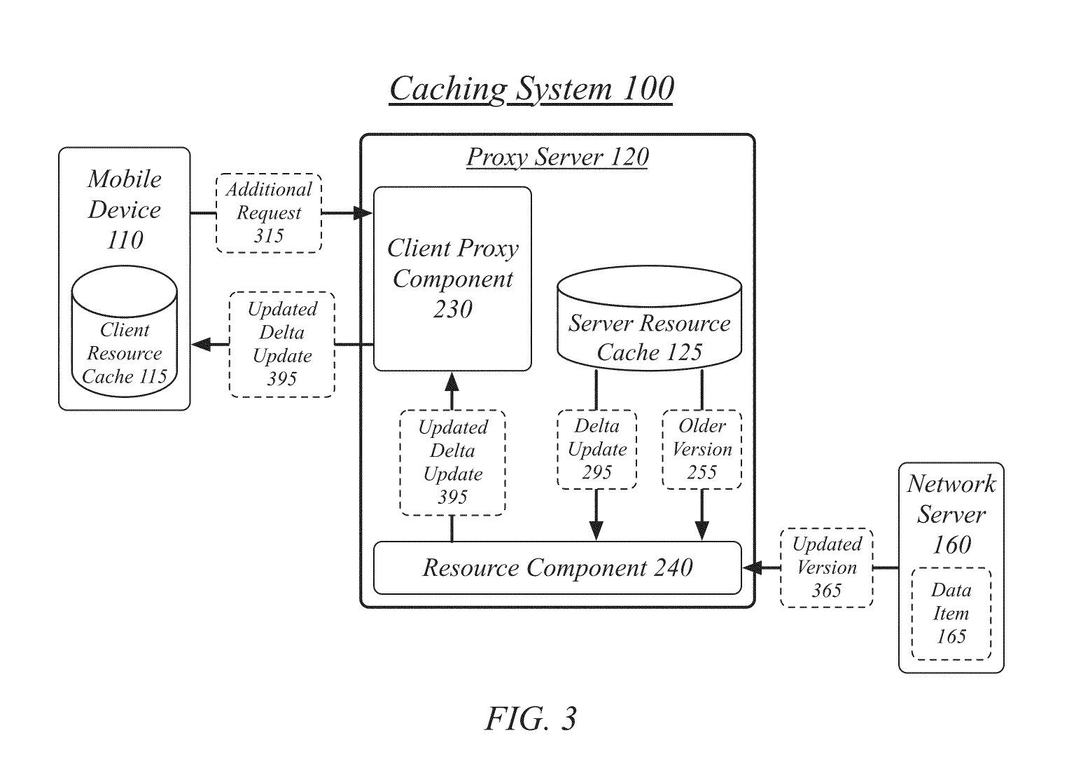

FIG. 3 illustrates an embodiment of the caching system 100 performing an updated delta update.

The proxy server 120 may store a delta update 295 with an older version 255 to effectively cache the current version 265 of the data item 165. When an updated version 365 more recent than the cached current version 265 is retrieved, the cached delta update 295 may be used to reconstructed the previously-current version 165 for the creation of an updated delta update 395 to update the mobile device 110 to the most recent updated version 365.

The client proxy component 230 may receive an additional request 315 from a mobile device 110, the additional request 315 comprising the current cached resource hash that corresponds to the current version 265, that current version 165 current to the time that it was retrieved. The resource component 240 may determine that the network server 160 stores an updated version 365 of the data item 165 more recent than the current version 265 cached by the mobile device 110. The resource component 240 may generate an updated delta update 395 comprising the differences between the current version 265 and the updated version 265. In some cases, the resource component 240 may be able to retrieve the current version 265 from the server resource cache 125.

However, in some cases, the proxy server 120 may store the delta update 295 between the older version 255 and the current version 265 along with the older version 255 in order to be able to retrieve both the older version 255 and reconstruct the current version 265 without having to fully store both. As such, upon determining that the server resource cache 125 does not store the current version 265 but does store the older version 255 and the delta update 295 between the older version 255 and the current version 265, the resource component 240 may retrieve the older version 255 and the delta update 295 and use them to reconstruct the current version 265. The resource component 240 may then use the reconstructed current version 265 in comparison with the updated version 365 to generated the updated delta update 395. The updated delta update 395 may then also be stored in the server resource cache 125 indexed by an updated cached resource hash generated from the updated delta update 395 so as to empower the proxy server 120 to retrieve or regenerate any of the older version 255, current version 265, or updated version 365 of the data item 165.

As such, in some cases, the client proxy component 230 may receive a further request from a mobile device for the data item 165 and respond with a further delta update based on multiple cached delta updates. The resource component 240 may determine that the server resource cache 125 contains two or more cached delta updates corresponding to the data item, retrieve the two or more cached delta updates from the server resource cache 125, and combine the two or more cached delta updates to form a delta update.

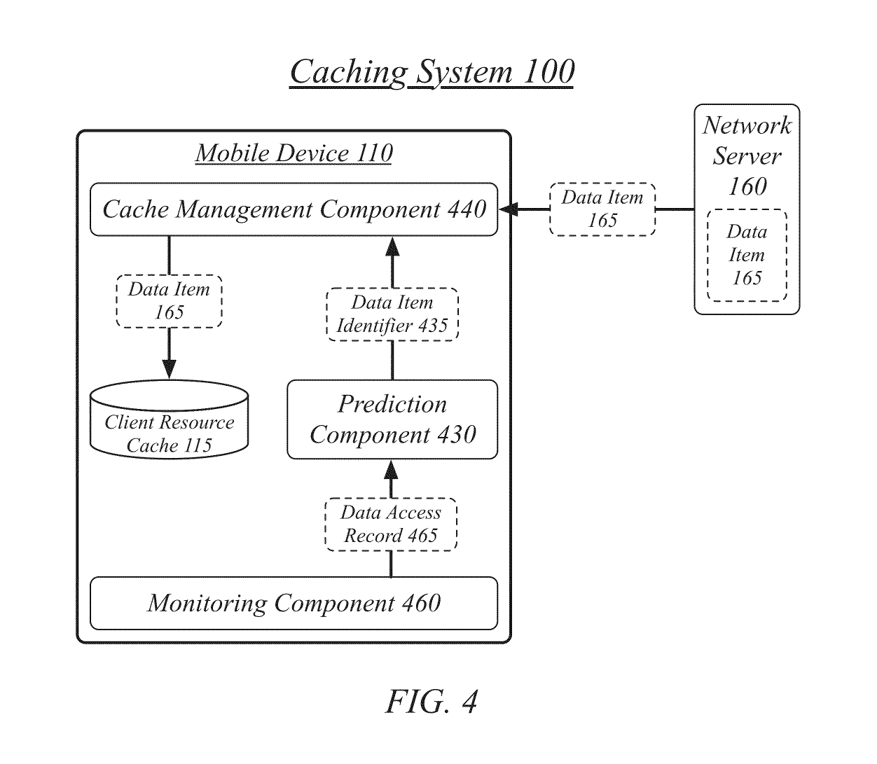

FIG. 4 illustrates an embodiment of the caching system 100 caching a predicted data item 165. The mobile device 110 may identify a data item 165 that a user of the mobile device 110 may have an interest in viewing in the future. The mobile device 110 may cache the data item 165 in advance of a request for the data item 165.

The mobile device 110 may comprise a cache management component 440, a prediction component 430, and a monitoring component 460. The mobile device 110 may be generally arranged to retrieve data items for its users, either on demand or in anticipation of their demands, to display the data items for its users, and to perform operations related to the display and use of data items.

The prediction component 430 may predict a user interest in receiving a data item 165 on a mobile device 110, the mobile device 110 connected to a particular data network. The monitoring component may record a data access record 465 of data access performed on behalf of the user of the mobile device 110. The prediction component 430 may determine a data access pattern based on the data access record 465, the data access pattern indicating the predicted user interest in receiving the data item 165 on the device in an identified user context. The prediction component 430 may determine a current user context associated with the mobile device 110. The prediction component 430 may predict the user interest in receiving the data item 165 based on a correspondence between the current user context and the identified user context. The prediction component 430 may pass a data item identifier 434 to the cache management component 440 to inform the cache management component 440 of the predict interest. The data item identifier 434 may comprise an address, such as a URL, for the data item 165.

The cache management component 440 may determine that the data network is associated with a pre-caching policy, retrieve the data item 165 from a network server 160 in response to the predicted user interest and the determination that the data network is associated with the pre-caching policy, and cache the data item 165 on the mobile device in a client resource cache 115. The data network may comprise a Wi-Fi network with the mobile device 110 comprising a smartphone operative to operate on both a non-metered Wi-Fi network and a metered cellular data network. The cache management component 440 may associate non-metered networks, such as a Wi-Fi network, with a pre-caching policy based on them being non-metered. The mobile device 110 being connected to any Wi-Fi network may be associated with a pre-caching policy. Caching the data item 165 while on a non-metered network may serve to make the data item 165 available without the use of, or with a reduced use of, a metered data network such as a cellular data network when eventually asked for by the user.

The user context may be elements of a user's use of a mobile device 110 identified as being associated with data item interest. The user context used in predicting the user interest may comprise one or more of geographic location, time of day, current app usage, and historic app usage. For example, the prediction component 430 may determine that a user habitually visit a particular coffee shop sometime in the morning before going to a nearby park to enjoy their coffee. While at the park, the user may browse various websites using a smartphone or tablet device. The caching system 100 may make use of free Wi-Fi in the coffee shop to download the most current versions of the various websites for display in the park. By having the websites cached, the mobile device 110 may only use its cellular data to retrieve delta updates from the most current versions and to retrieve any websites not predicted. It will be appreciated that data items other than websites may also be predicted, retrieved and cached, such as data items for mobile applications on the mobile device 110. As such, predicting the user interest in receiving the data item 165 on the mobile device 110 may comprise a determination that the mobile device 110 has repeatedly accessed the data item in a time period, the time period associated with use of the mobile device 110 on a cellular network, wherein determining that the data network is associated with the pre-caching policy comprises a determination that the mobile device 110 is connected to a Wi-Fi network.

A user of a mobile device 110 may be a member of a social-networking service. A news feed may be available for the user in association with their user account on the social-networking service. The news feed may comprise notifications about activities of friends and other items of interests. One or more notifications in the news feed may be associated with network-accessible data items, such as data item 165. For example, users may post links to web pages, post user-uploaded images, and other online resources hosted by either the social-networking service or a third party. Any of these data items, whether hosted by the social-networking service or a third party, may be retrieved by the user. The user having a notification associated with a data item 165 may therefore form the basis for a prediction that the user has an interest in the data item 165. As such, the prediction component 430 may predict the user interest in receiving the data item 165 on the mobile device 110 by determining that the user has a social networking notification associated with the data item 165.

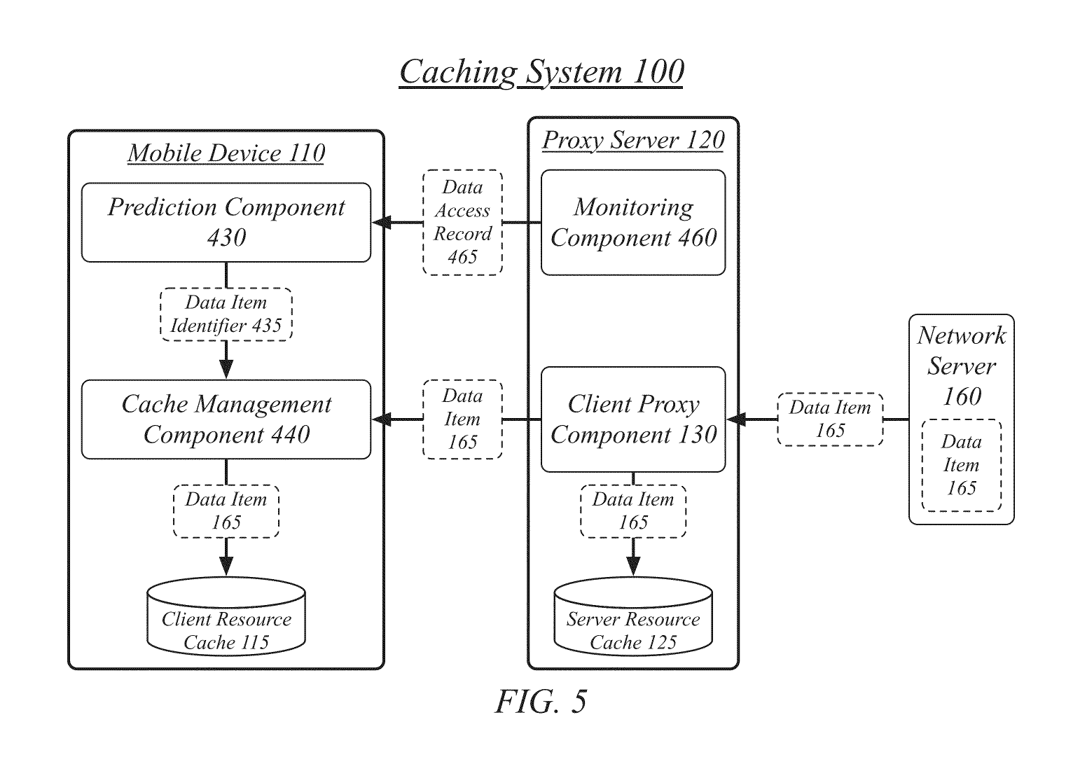

FIG. 5 illustrates an embodiment of the caching system 100 caching a data item 165 predicted by a proxy server 120. In some embodiments, the proxy server 120 may predict the user interest in the data item 165, such as where the proxy server 120 has access to information about the user of the mobile device 110 better enabling it to predict user interest.

In some embodiments, such as the illustrated embodiment of FIG. 4, the monitoring component 460 may be located on the mobile device 110. However, in other embodiments, the monitoring component 460 may be located on the proxy server 120. The data access record 465 may be recorded at a proxy server 120, the proxy server 120 associated with network access by the mobile device 110. In some embodiments, a monitoring component 460 may be executed by each of the mobile device 110 and the proxy server 120.

The retrieval of the data item 165 by the cache management component 440 may comprise using the client proxy component 130 as a proxy for a network request 215 for the data item 165. This may allow the client proxy component 130 to cache a copy of the data item 165. The version of the data item 165 cached by the mobile device 110 and the proxy server 120 may comprise an older version 255 of the data item 165. When the user later requests the data item 165 a newer current version 265 may be available. The client proxy component 130 may be operative to transmit a delta update 295 between the older version 25 and the current version 265 to update the version cached in response to the prediction of user interest to the version that is current at the time of an actual expression of immediate user interest in the data item 165. This mobile device 110 may therefore benefit in using the proxy server 120 even when operating on a non-metered network so as to have access to the reduced-data demands of receiving delta updates for cached items when on a metered network.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

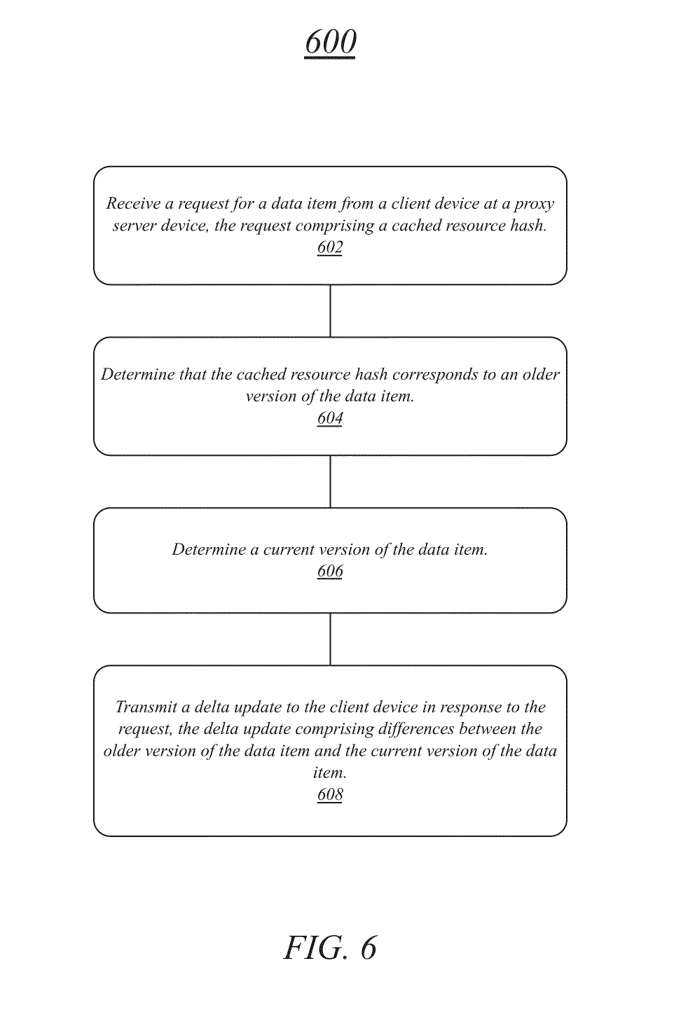

FIG. 6 illustrates one embodiment of a logic flow 600. The logic flow 600 may be representative of some or all of the operations executed by one or more embodiments described herein.

In the illustrated embodiment shown in FIG. 6, the logic flow 600 may receive a request 215 for a data item 165 from a client device at a proxy server device, the request comprising a cached resource hash at block 602.

The logic flow 600 may determine that the cached resource hash corresponds to an older version 255 of the data item 165 at block 604.

The logic flow 600 may determine a current version 265 of the data item 165 at block 606.

The logic flow 600 may transmit a delta update 295 to the client device in response to the request 215, the delta update 295 comprising differences between the older version 255 of the data item 165 and the current version 265 of the data item 165 at block 608.

The embodiments are not limited to this example.

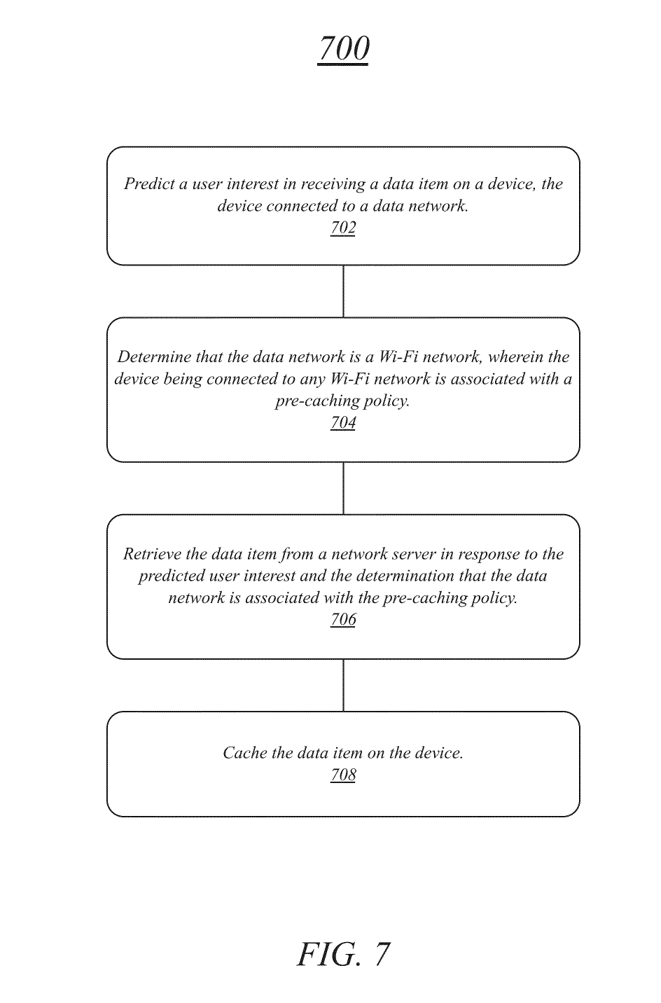

FIG. 7 illustrates one embodiment of a logic flow 700. The logic flow 700 may be representative of some or all of the operations executed by one or more embodiments described herein.

In the illustrated embodiment shown in FIG. 7, the logic flow 700 may predict a user interest in receiving a data item 165 on a device, the device connected to a data network at block 702.

The logic flow 700 may determine that the data network is a Wi-Fi network, wherein the device being connected to any Wi-Fi network is associated with a pre-caching policy at block 704.

The logic flow 700 may retrieve the data item 165 from a network server 160 in response to the predicted user interest and the determination that the data network is associated with the pre-caching policy at block 706.

The logic flow 700 may cache the data item on the device at block 708.

The embodiments are not limited to this example.

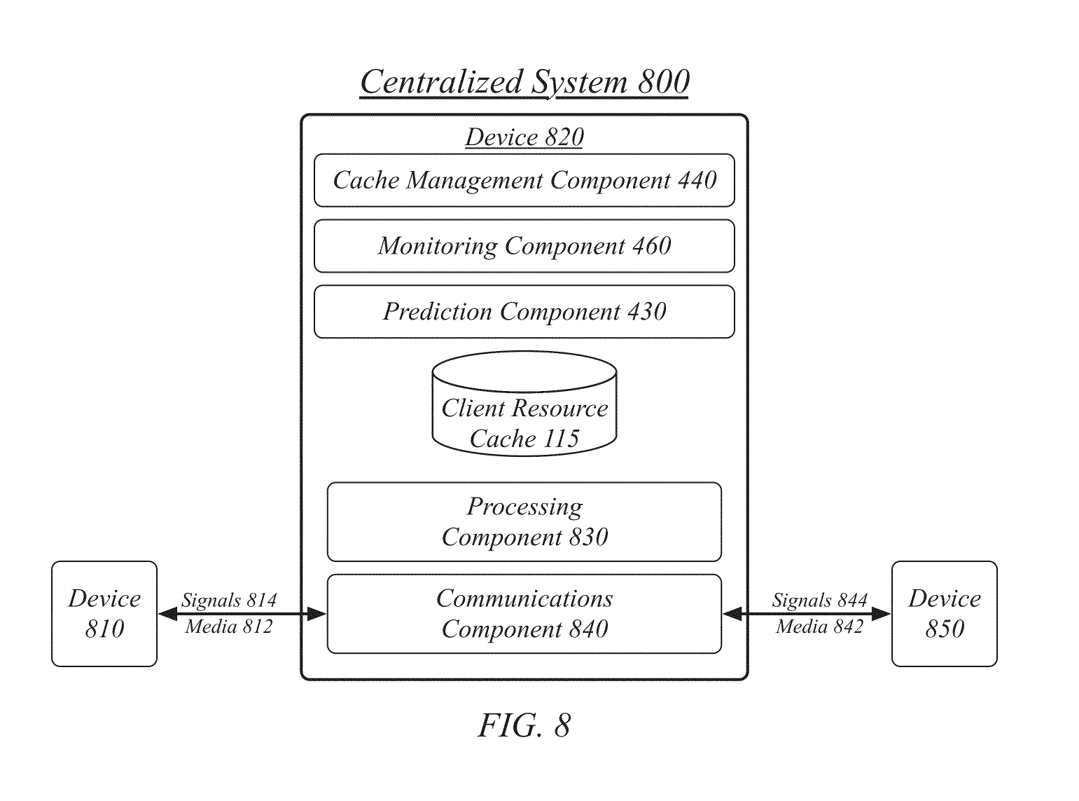

FIG. 8 illustrates a block diagram of a centralized system 800. The centralized system 800 may implement some or all of the structure and/or operations for the caching system 100 in a single computing entity, such as entirely within a single device 820.

The device 820 may comprise any electronic device capable of receiving, processing, and sending information for the caching system 100. Examples of an electronic device may include without limitation an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The device 820 may execute processing operations or logic for the caching system 100 using a processing component 830. The processing component 830 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 820 may execute communications operations or logic for the caching system 100 using communications component 840. The communications component 840 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 840 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 812, 842 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 820 may communicate with other devices 810, 850 over a communications media 812, 842, respectively, using communications signals 814, 844, respectively, via the communications component 840. The devices 810, 850 may be internal or external to the device 820 as desired for a given implementation. The device 820 may correspond to the mobile device 110. The device 820 may execute the cache management component 440, the monitoring component 460, and the prediction component 430 and comprise the client resource cache 115. The devices 810, 850 may comprise network servers such as network server 160 hosting data item 165. The devices 810, 850 may comprise proxy servers such as proxy server 120.

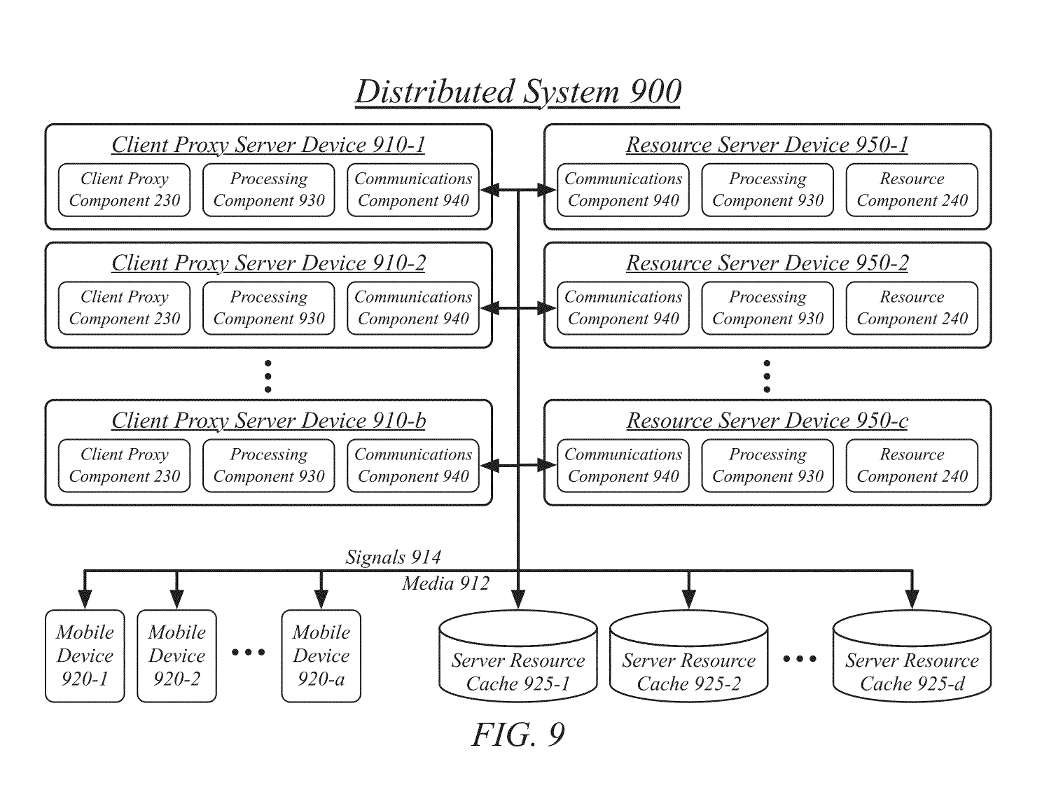

FIG. 9 illustrates a block diagram of a distributed system 900. The distributed system 900 may distribute portions of the structure and/or operations for the caching system 100 across multiple computing entities. Examples of distributed system 900 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 900 may comprise a client proxy server device 910 and a resource server device 950. In general, the client proxy server device 910 and the resource server device 950 may be the same or similar to the device 820 as described with reference to FIG. 8. For instance, the client proxy server device 910 and the resource server device 950 may each comprise a processing component 930 and a communications component 940 which are the same or similar to the processing component 830 and the communications component 840, respectively, as described with reference to FIG. 8. In another example, the devices 910, 950 may communicate over a communications media 912 using communications signals 914 via the communications components 940.

The client proxy server device 910 may comprise or employ one or more client programs that operate to perform various methodologies in accordance with the described embodiments. In one embodiment, for example, the client proxy server device 910 may implement the client proxy component 230.

The resource server device 950 may comprise or employ one or more server programs that operate to perform various methodologies in accordance with the described embodiments. In one embodiment, for example, the resource server device 950 may implement the resource component 240.

The signals 914 sent over media 912 may comprise signals integrating the operations of the client proxy components 230 and resource component 240. The signals 914 may comprise signals exchanged with mobile devices 920, the mobile devices client devices of the proxy server operations performed by the server devices 910, 950. The signals 914 may comprise the storage, search, and retrieval of data in a distributed server resource cache 925.

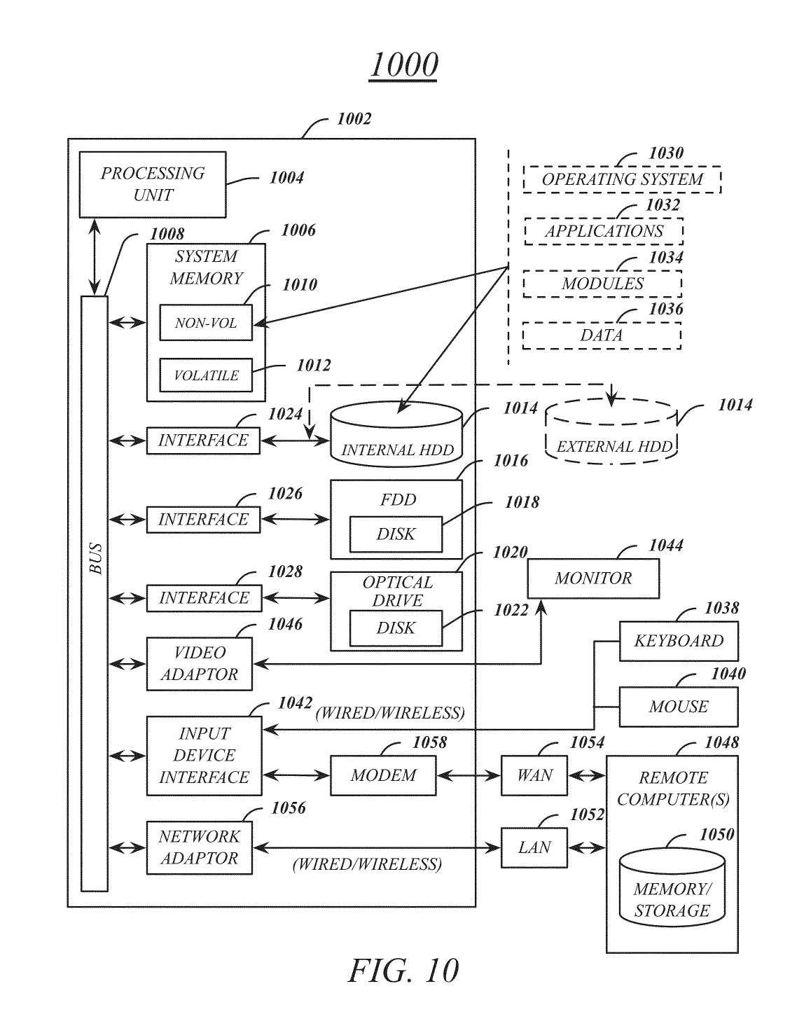

FIG. 10 illustrates an embodiment of an exemplary computing architecture 1000 suitable for implementing various embodiments as previously described. In one embodiment, the computing architecture 1000 may comprise or be implemented as part of an electronic device. Examples of an electronic device may include those described with reference to FIG. 8 and FIG. 9, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 1000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1000.

As shown in FIG. 10, the computing architecture 1000 comprises a processing unit 1004, a system memory 1006 and a system bus 1008. The processing unit 1004 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1004.

The system bus 1008 provides an interface for system components including, but not limited to, the system memory 1006 to the processing unit 1004. The system bus 1008 can be any of several types of bus structure that may further interconnect to a memory bus (with or without a memory controller), a peripheral bus, and a local bus using any of a variety of commercially available bus architectures. Interface adapters may connect to the system bus 1008 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1000 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1006 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 10, the system memory 1006 can include non-volatile memory 1010 and/or volatile memory 1012. A basic input/output system (BIOS) can be stored in the non-volatile memory 1010.

The computer 1002 may include various types of computer-readable storage media in the form of one or more lower speed memory units, including an internal (or external) hard disk drive (HDD) 1014, a magnetic floppy disk drive (FDD) 1016 to read from or write to a removable magnetic disk 1018, and an optical disk drive 1020 to read from or write to a removable optical disk 1022 (e.g., a CD-ROM or DVD). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1010, 1012, including an operating system 1030, one or more application programs 1032, other program modules 1034, and program data 1036. In one embodiment, the one or more application programs 1032, other program modules 1034, and program data 1036 can include, for example, the various applications and/or components of the caching system 100.

A user can enter commands and information into the computer 1002 through one or more wire/wireless input devices, for example, a keyboard 1038 and a pointing device, such as a mouse 1040. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, and so forth.

A monitor 1044 or other type of display device is also connected to the system bus 1008 via an interface, such as a video adaptor 1046. The monitor 1044 may be internal or external to the computer 1002. In addition to the monitor 1044, a computer typically includes other peripheral output devices, such as speakers, printers, and so forth.

The computer 1002 may operate in a networked environment using logical connections via wire and/or wireless communications to one or more remote computers, such as a remote computer 1048. The remote computer 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, connects to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with wire and wireless devices or entities using the IEEE 802 family of standards, such as wireless devices operatively disposed in wireless communication (e.g., IEEE 802.10 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.10x (a, b, g, n, etc.) to provide secure, reliable, fast wireless connectivity. A Wi-Fi network can be used to connect computers to each other, to the Internet, and to wire networks (which use IEEE 802.3-related media and functions).

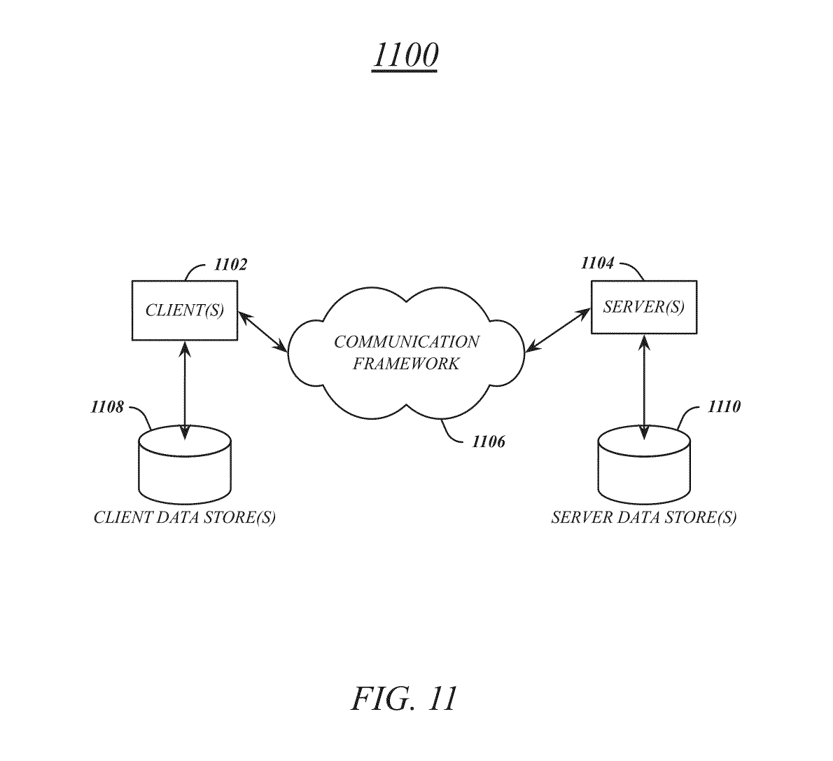

FIG. 11 illustrates a block diagram of an exemplary communications architecture 1100 suitable for implementing various embodiments as previously described. The communications architecture 1100 includes various common communications elements, such as a transmitter, receiver, transceiver, radio, network interface, baseband processor, antenna, amplifiers, filters, power supplies, and so forth. The embodiments, however, are not limited to implementation by the communications architecture 1100.

As shown in FIG. 11, the communications architecture 1100 comprises includes one or more clients 1102 and servers 1104. The clients 1102 may implement the client device 910. The servers 1104 may implement the server device 950. The clients 1102 and the servers 1104 are operatively connected to one or more respective client data stores 1108 and server data stores 1110 that can be employed to store information local to the respective clients 1102 and servers 1104, such as cookies and/or associated contextual information.

The clients 1102 and the servers 1104 may communicate information between each other using a communication framework 1106. The communications framework 1106 may implement any well-known communications techniques and protocols. The communications framework 1106 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1106 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1102 and the servers 1104. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

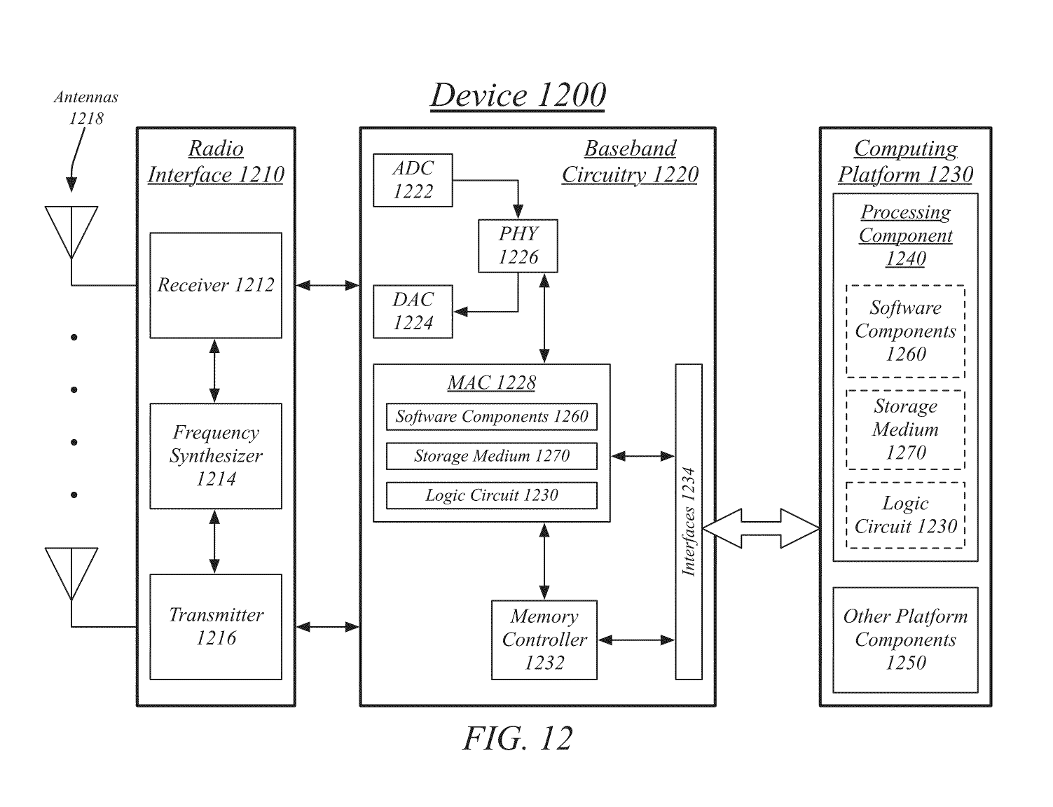

FIG. 12 illustrates an embodiment of a device 1200 for use in a multicarrier OFDM system, such as the caching system 100. Device 1200 may implement, for example, software components 1260 as described with reference to caching system 100 and/or a logic circuit 1230. The logic circuit 1230 may include physical circuits to perform operations described for the caching system 100. As shown in FIG. 12, device 1200 may include a radio interface 1210, baseband circuitry 1220, and computing platform 1230, although embodiments are not limited to this configuration.

The device 1200 may implement some or all of the structure and/or operations for the caching system 100 and/or logic circuit 1230 in a single computing entity, such as entirely within a single device. Alternatively, the device 1200 may distribute portions of the structure and/or operations for the caching system 100 and/or logic circuit 1230 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 1210 may include a component or combination of components adapted for transmitting and/or receiving single carrier or multi-carrier modulated signals (e.g., including complementary code keying (CCK) and/or orthogonal frequency division multiplexing (OFDM) symbols) although the embodiments are not limited to any specific over-the-air interface or modulation scheme. Radio interface 1210 may include, for example, a receiver 1212, a transmitter 1216 and/or a frequency synthesizer 1214. Radio interface 1210 may include bias controls, a crystal oscillator and/or one or more antennas 1218. In another embodiment, radio interface 1210 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 1220 may communicate with radio interface 1210 to process receive and/or transmit signals and may include, for example, an analog-to-digital converter 1222 for down converting received signals, a digital-to-analog converter 1224 for up converting signals for transmission. Further, baseband circuitry 1220 may include a baseband or physical layer (PHY) processing circuit 1256 for PHY link layer processing of respective receive/transmit signals. Baseband circuitry 1220 may include, for example, a processing circuit 1228 for medium access control (MAC)/data link layer processing. Baseband circuitry 1220 may include a memory controller 1232 for communicating with processing circuit 1228 and/or a computing platform 1230, for example, via one or more interfaces 1234.

In some embodiments, PHY processing circuit 1226 may include a frame construction and/or detection module, in combination with additional circuitry such as a buffer memory, to construct and/or deconstruct communication frames, such as radio frames. Alternatively or in addition, MAC processing circuit 1228 may share processing for certain of these functions or perform these processes independent of PHY processing circuit 1226. In some embodiments, MAC and PHY processing may be integrated into a single circuit.

The computing platform 1230 may provide computing functionality for the device 1200. As shown, the computing platform 1230 may include a processing component 1240. In addition to, or alternatively of, the baseband circuitry 1220, the device 1200 may execute processing operations or logic for the caching system 100 and logic circuit 1230 using the processing component 1240. The processing component 1240 (and/or PHY 1226 and/or MAC 1228) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 1230 may further include other platform components 1250. Other platform components 1250 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 1200 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, node B, evolved node B (eNB), subscriber station, mobile subscriber center, radio network controller, router, hub, gateway, bridge, switch, machine, or combination thereof. Accordingly, functions and/or specific configurations of device 1200 described herein, may be included or omitted in various embodiments of device 1200, as suitably desired. In some embodiments, device 1200 may be configured to be compatible with protocols and frequencies associated one or more of the 3GPP LTE Specifications and/or IEEE 1202.16 Standards for WMANs, and/or other broadband wireless networks, cited herein, although the embodiments are not limited in this respect.

Embodiments of device 1200 may be implemented using single input single output (SISO) architectures. However, certain implementations may include multiple antennas (e.g., antennas 1218) for transmission and/or reception using adaptive antenna techniques for beamforming or spatial division multiple access (SDMA) and/or using MIMO communication techniques.

The components and features of device 1200 may be implemented using any combination of discrete circuitry, application specific integrated circuits (ASICs), logic gates and/or single chip architectures. Further, the features of device 1200 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 1200 shown in the block diagram of FIG. 12 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

A computer-implemented method may comprise receiving a request for a data item from a client device at a proxy server device, the request comprising a cached resource hash; determining that the cached resource hash corresponds to an older version of the data item; determining a current version of the data item; and transmitting a delta update to the client device in response to the request, the delta update comprising differences between the older version of the data item and the current version of the data item.

A computer-implemented method may further comprise retrieving the current version of the data item from a network server associated with the data item; retrieving the older version of the data item from a resource cache associated with the proxy server device; and generating the delta update by calculating a differential between the older version of the data item and the current version of the data item.

A computer-implemented method may further comprise generating a current version cache resource hash corresponding to the current version of the data item; and storing the delta update in the resource cache, the delta update indexed by the current version cache resource hash generated from the current version of the data item.

A computer-implemented method may further comprise, the proxy server device associated with a resource cache, the resource cache containing two or more cached delta updates corresponding to the data item, retrieving the two or more cached delta updates from the resource cache; and combining the two or more cached delta updates to form the delta update.

A computer-implemented method may further comprise, the cached resource hash corresponding to a data item template generated from the older version of the data item, the data item template comprising static elements of the data item.

A computer-implemented method may further comprise, the cached resource hash corresponding to a modified older version of the data item, the modified older version excluding one or more dynamic elements of the data item.

A computer-implemented method may further comprise, wherein a timestamp for the data item comprises at least one of the one or more dynamic elements of the data item excluded from the modified older version during generation of the cached resource hash.

A computer-implemented method may further comprise, wherein determining that the cached resource hash corresponds to the older version of the data item comprises performing an index-based retrieval against a resource cache, the cached resource hash used as an index for the index-based retrieval.

An apparatus may comprise a processor circuit on a device; a client proxy component operative on the processor circuit to receive a request for a data item from a client device at a proxy server device, the request comprising a cached resource hash and transmit a delta update to the client device in response to the request, the delta update comprising differences between an older version of the data item and a current version of the data item; and a resource component operative on the processor circuit to determine that the cached resource hash corresponds to the older version of the data item and determine the current version of the data item. The apparatus may be operative to implement any of the computer-implemented methods described herein.

A computer-implemented method may comprise predicting a user interest in receiving a data item on a device, the device connected to a data network; determining that the data network is associated with a pre-caching policy; retrieving the data item from a network server in response to the predicted user interest and the determination that the data network is associated with the pre-caching policy; and caching the data item on the device.

A computer-implemented method may further comprise, the data network comprising a Wi-Fi network, the Wi-Fi network associated with the pre-caching policy based on it being non-metered, the device comprising a smartphone.

A computer-implemented method may further comprise determining a user context associated with a user of the device; and predicting the user interest in receiving the data item based on the user context.

A computer-implemented method may further comprise, the user context comprising one or more of geographic location, time of day, current app usage, and historic app usage.

A computer-implemented method may further comprise recording a data access record of data access performed on behalf of the user of the device; determining a data access pattern based on the data access record, the data access pattern indicating the predicted user interest in receiving the data item on the device in an identified user context; and determining a current user context associated with the device; and predicting the user interest in receiving the data item based on a correspondence between the current user context and the identified user context.

A computer-implemented method may further comprise, the data access record recorded at a proxy server, the proxy server associated with network access by the device.

A computer-implemented method may further comprise, wherein predicting the user interest in receiving the data item on the device comprises a determination that the device has repeatedly accessed the data item in a time period, the time period associated with use of the device on a cellular network, wherein determining that the data network is associated with the pre-caching policy comprises a determination that the device is connected to a Wi-Fi network.

A computer-implemented method may further comprise, wherein predicting the user interest in receiving the data item on the device comprises determining that the user has a social networking notification associated with the data item.

An apparatus may comprise a processor circuit on a device; a prediction component operative on the processor circuit to predict a user interest in receiving a data item on a device, the device connected to a data network; and a cache management component operative on the processor circuit to determine that the data network is associated with a pre-caching policy, retrieve the data item from a network server in response to the predicted user interest and the determination that the data network is associated with the pre-caching policy, and cache the data item on the device. The apparatus may be operative to implement any of the computer-implemented methods described herein.

At least one computer-readable storage medium may comprise instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

What is claimed is:

1. A computer-implemented method, comprising:
receiving a request for a data item from a client device at a proxy server device, the request comprising a cached resource hash;
determining that the cached resource hash corresponds to an older version of the data item;
determining a current version of the data item; and
transmitting a delta update to the client device in response to the request, the delta update comprising differences between the older version of the data item and the current version of the data item.

2. The method of claim 1, comprising:
retrieving the current version of the data item from a network server associated with the data item;
retrieving the older version of the data item from a resource cache associated with the proxy server device; and
generating the delta update by calculating a differential between the older version of the data item and the current version of the data item.

3. The method of claim 2, comprising:
generating a current version cache resource hash corresponding to the current version of the data item; and
storing the delta update in the resource cache, the delta update indexed by the current version cache resource hash generated from the current version of the data item.

4. The method of claim 1, the proxy server device associated with a resource cache, the resource cache containing two or more cached delta updates corresponding to the data item, comprising:
retrieving the two or more cached delta updates from the resource cache; and
combining the two or more cached delta updates to form the delta update.

5. The method of claim 1, the cached resource hash corresponding to a data item template generated from the older version of the data item, the data item template comprising static elements of the data item.

6. The method of claim 1, the cached resource hash corresponding to a modified older version of the data item, the modified older version excluding one or more dynamic elements of the data item.

7. The method of claim 6, wherein a timestamp for the data item comprises at least one of the one or more dynamic elements of the data item excluded from the modified older version during generation of the cached resource hash.

8. The method of claim 1, wherein determining that the cached resource hash corresponds to the older version of the data item comprises performing an index-based retrieval against a resource cache, the cached resource hash used as an index for the index-based retrieval.

9. An apparatus, comprising:
a processor circuit on a device;
a client proxy component operative on the processor circuit to receive a request for a data item from a client device at a proxy server device, the request comprising a cached resource hash and transmit a delta update to the client device in response to the request, the delta update comprising differences between an older version of the data item and a current version of the data item; and
a resource component operative on the processor circuit to determine that the cached resource hash corresponds to the older version of the data item and determine the current version of the data item.

10. The apparatus of claim 9, the resource component operative to retrieve the current version of the data item from a network server associated with the data item, retrieve the older version of the data item from a resource cache associated with the proxy server device, and generate the delta update by calculating a differential between the older version of the data item and the current version of the data item.

11. The apparatus of claim 10, the resource component operative to generate a current version cache resource hash corresponding to the current version of the data item and store the delta update in the resource cache, the delta update indexed by the current version cache resource hash generated from the current version of the data item.

12. The apparatus of claim 9, the proxy server device associated with a resource cache, the resource cache containing two or more cached delta updates corresponding to the data item, the resource component operative to retrieve the two or more cached delta updates from the resource cache and combine the two or more cached delta updates to form the delta update.

13. The apparatus of claim 9, the cached resource hash corresponding to a data item template generated from the older version of the data item, the data item template comprising static elements of the data item.

14. The apparatus of claim 9, the cached resource hash corresponding to a modified older version of the data item, the modified older version excluding one or more dynamic elements of the data item.

15. The apparatus of claim 9, wherein determining that the cached resource hash corresponds to the older version of the data item comprises performing an index-based retrieval against a resource cache, the cached resource hash used as an index for the index-based retrieval.

16. At least one computer-readable storage medium comprising instructions that, when executed, cause a system to:
receive a request for a data item from a client device at a proxy server device, the request comprising a cached resource hash;
determine that the cached resource hash corresponds to an older version of the data item;
determine a current version of the data item; and
transmit a delta update to the client device in response to the request, the delta update comprising differences between the older version of the data item and the current version of the data item.

17. The computer-readable storage medium of claim 16, comprising further instructions that, when executed, cause a system to:
retrieve the current version of the data item from a network server associated with the data item;
retrieve the older version of the data item from a resource cache associated with the proxy server device; and
generate the delta update by calculating a differential between the older version of the data item and the current version of the data item.

18. The computer-readable storage medium of claim 16, the cached resource hash corresponding to a data item template generated from the older version of the data item, the data item template comprising static elements of the data item.

19. The computer-readable storage medium of claim 16, the cached resource hash corresponding to a modified older version of the data item, the modified older version excluding one or more dynamic elements of the data item.

20. The computer-readable storage medium of claim 16, wherein determining that the cached resource hash corresponds to the older version of the data item comprises performing an index-based retrieval against a resource cache, the cached resource hash used as an index for the index-based retrieval.
